(19) United States
(12) Patent Application Publication
(10) Pub. No.: US 2022/0364441 A1
(43) Pub. Date: Nov. 17, 2022

(54) Systems, Methods and Devices for Geologic Storage of CO2 from Modular Point Sources

(71) Applicant: Furno Materials Inc., Palo Alto, CA (US)

(72) Inventors: Gurinder Nagra, Palo Alto, CA (US); Gurinder Nagra, Palo Alto, CA (US)

(73) Assignee: Furno Materials Inc., Palo Alto, CA (US)

(21) Appl. No.: 17/684,398

(22) Filed: Mar. 1, 2022

Related U.S. Application Data
(63) Continuation-in-part of application No. 17/384,672, filed on Jul. 23, 2021.
Application No. 17/384,672 is a continuation-in-part of application No. 17/497,929, filed on Oct. 9, 2021.
(60) Provisional application No. 63/055,826, filed on Jul. 23, 2020.
(60) Provisional application No. 63/108,418, filed on Nov. 1, 2020.
(60) Provisional application No. 63/212,529, filed on Jun. 18, 2021.
(60) Provisional application No. 63/212,535, filed on Jun. 18, 2021.
(60) Provisional application No. 63/155,664, filed on Mar. 2, 2021.

(51) Int. Cl. E21B 41/00

(52) U.S. Cl. CPC E21B 41/0064

(57) ABSTRACT

Methods, systems and devices for the subsurface storage of CO₂ from a modular industrial point source. In an embodiment the CO₂ is from a modular cement plant. In an embodiment the CO₂ from a point source is dissolved in saline/brine solution and pumped into a subterranean storage space.

This application: (i) claims priority to, and under 35 U.S.C. § 119(e)(1) the benefit of the filing date of, U.S. provisional application Ser. No. 63/155,664 filed Mar. 2, 2021; and (ii) is a continuation in part of U.S. application Ser. No. 17,384,672 filed Jul. 23, 2021, which claims priority to U.S. provisional applications Ser. No. 63/055,826 filed July 23, 2020, Ser. No. 63/108,418 filed Nov. 1, 2020, Ser. No. 63/212,529 filed Jun. 18, 2021, and Ser. No. 63/212,535 filed Jun. 18, 2021; and, (iii) is a continuation in part of U.S. application Ser. No. 17/497,929 filed Oct. 9, 2021, the entire disclosure of each of which is incorporated herein by reference.

### BACKGROUND OF THE INVENTION

### Field of the Invention

The present inventions relate to systems, methods and devices to store CO₂ by dissolving it in water/brine and then subsequently sequestering it geologically.

Geologic storage of CO₂ in the subsurface is vital if we are to reach the UNFCC's goal to limit warming to below 1.5° C. or even the less stringent goal of 2° C. The capture and storage of CO₂ prevents CO₂ emissions by permanently storing CO₂ from various sources such as industrial, processing plants and power plants, in subsurface spaces, such as geologic formations. Options for geologic storage of CO₂ include subsurface spaces, such as depleted oil reservoirs, deep saline formations, coal beds and basalt formations, to name a few. To date the storage of CO₂ in these subsurface spaces has largely been focused on storing CO₂ in a supercritical fluid form. The primary need for using a supercritical fluid has been that it provides at least a potential for efficient utilization of underground storage space, the potential for efficient injection of the CO₂ into the underground storage space and a density of CO₂ that is less prone to leakage than CO₂ as a gas.

Furthermore, prior to the present inventions, it was believed that to be technically and economically viable on a mass scale the use of a supercritical fluid of CO₂ was required. This prior need to the use supercritical fluids added additional costs and complexity, both operational and capital, to the building and operation of a CO₂ subsurface sequestration system. As a result, among may drawbacks of the prior supercritical fluid CO₂ approach, it is believed that it could only potentially be viable for very large point source emissions. An additional, and potentially serious problem with the prior supercritical fluid CO₂ approach is that supercritical CO₂ fluid has a lower density than water. As such the supercritical fluid CO₂ is buoyant and must be sequestered below 800 m depth and in a permeable formation below a caprock. The need for the caprock and the depth of 800 m are required for the CO₂ to remain in its super critical state. Should the CO₂ not be maintained in its supercritical state after sequestration, it could escape the subterranean formation, and this escape could present serious personal, property and environmental risks.

Some successful pilot projects, using supercritical CO₂ fluid, such as the Deep-Sea Project by Statoil have been conducted on a large scale.

It is believed injecting CO₂ into deep geological formations at carefully selected sites has the potential to enable storage for long periods of time with a predicted 99% of the CO₂ being retained for 1000 years. An extensive review of existing CO₂Capture and Storage (CCS) projects and technology is given in the IPCC Special report on Carbon Dioxide Capture and Storage (CCS) (“Carbon Dioxide Capture and Storage”, IPCC, 2005, editors: Metz et al., Cambridge University Press, UK; also available at: http://www.ipcc.ch). The paper SPE 127096 “An overview of active large-scale CO₂ storage projects”, I. Wright et al. presented at the 2009 SPE International Conference on CO₂ capture, Storage and Utilization held in San Diego, Calif., USA 2-4 Nov. 2009 provides a more recent update on existing large-scale CO₂ storage projects. Some successful pilot projects, using supercritical CO₂ fluid, such as the Deep-Sea Project by Statoil have been conducted on a large scale. From reviewing these papers, it is clear that the present direction of the art is to continue using supercritical fluids of CO₂.

However, the cost for deep injection of a supercritical fluid below 800 m, the buoyant nature of supercritical CO₂ and the need for post-injection monitoring have put financial and regulatory barriers that prevent geologic storage from being technically, economically, or both, viable on any scale that would be beneficial to the environment. For example, in the case of the US the 45Q tax credit offers an attractive $50/ton for any facility that is able to sequester >25,000 t of CO₂/year. In spite of this significant governmental incentive, it is believed at the time of this application only one such tax credit has been granted, this is primarily due to the environmental approval required for a Type 6 well permits needed to store CO₂ as a supercritical fluid. Type 6 well permits are both scarce and an arduous multi-year's process, with only one having been granted to date. This is an enormous regulatory barrier that prevents the deployment of carbon storage technology using supercritical fluid.

As used herein, unless stated otherwise, the term “supercritical fluid” (“SCF”) and “supercritical” and similar such terms are to be given their broadest possible meaning and would include any substance or material that is heated above its critical temperature while being compressed above its critical pressure, which exhibits both liquid and gas properties. Typically, a SCF exists at a temperature and pressure above the substance's crucial point where district liquids and gases do not exist, but below the pressure required to compress the substance into a solid.

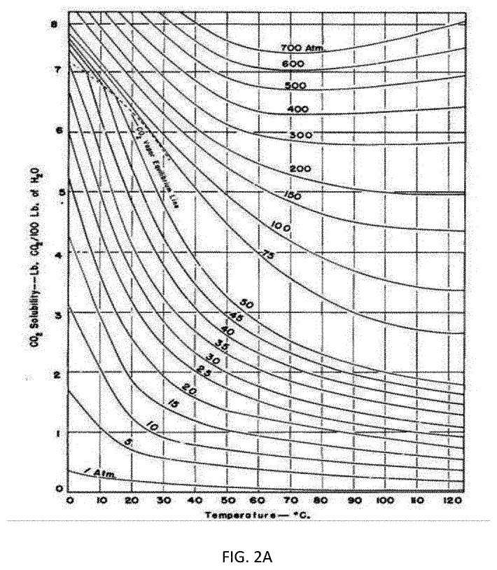

CO₂ exists as a supercritical fluid above its critical point, which is 31.0° C. (87.8° F.) and 7.3773 MPa (1,070 psi). FIG. 2A shows the phase diagram for CO₂ and the temperature and pressures where it exists as a SCF.

As used herein, unless expressly stated otherwise terms such as “at least”, “greater than”, also mean “not less than”, i.e., such terms exclude lower values unless expressly stated otherwise. Similarly, as used herein, unless expressly stated otherwise terms such as “less than”, also mean “not greater than”, i.e., such terms exclude greater values unless expressly stated otherwise.

As used herein, unless specified otherwise, the recitation of ranges of values, a range, from about “x” to about “y”, and similar such terms and quantifications, serve as merely shorthand methods of referring individually to separate values within the range. Thus, they include each item, feature, value, amount or quantity falling within that range. As used herein, unless specified otherwise, each and all individual points within a range are incorporated into this specification, and are a part of this specification, as if they were individually recited herein.

As used herein, unless stated otherwise, the term “cement” is to be given its broadest possible meaning and would include, materials that are made from lime, iron, silica and alumina at temperatures in the general range of about 2,500° F. (1,371° C.) to 2,800° F. (1,537.8° C.), materials that are made from calcium, silicon, aluminum, iron and gypsum at temperatures in the general range of about 2,500° F. (1,371° C.) to 2,800° F. (1,537.8° C.) roman cements, portland cements, hydraulic cements, blended hydraulic cements, materials that meet, portland-limestone cement, portland-slag cement, portland-pozzonlan cement, ternary blended cements, sulfate resistant cements, or have components that meet, one or more of the following American Society for Testing and Materials (“ASTM”) standards, (which standards are incorporated herein by reference) ASTM C150, ASTM C595, C1157, ASTM 109. The term cement includes the dry, wet and hardened states or forms of these materials.

As used herein, unless stated otherwise, the term “concrete” is to be given its broadest possible meaning and would include, materials that have an aggregate and a binder, which is typically cement. Water is added to this mixture and a chemical reaction takes place over time to provide a solid material or structure. The term concrete includes the dry, wet and hardened states of these materials.

Generally, the term “about” and the symbol “˜” as used herein, unless specified otherwise, is meant to encompass a variance or range of ±10%, the experimental or instrument error associated with obtaining the stated value, and the larger of these.

As used herein, unless stated otherwise, room temperature is 25° C. And, standard temperature and pressure is 25° C. and 1 atmosphere. Unless expressly stated otherwise all tests, test results, physical properties, and values that are temperature dependent, pressure dependent, or both, are provided at standard temperature and pressure.

This Background of the Invention section is intended to introduce various aspects of the art, which may be associated with embodiments of the present inventions. Thus, the foregoing discussion in this section provides a framework for better understanding the present inventions, and is not to be viewed as an admission of prior art.

### SUMMARY

There is a continuing and increasing need to for new and more efficient and environmentally sound, systems, equipment and methods for the geologic storage of CO₂ particularly from industrial emissions. There is a further long standing and unresolved need to eliminate the long-standing problems with the use of supercritical CO₂ fluids for the subsurface storage of CO₂. Among other industrial emissions, there is a particular, long standing, and unresolved need to sequester and reduce the CO₂ emissions from the cement industry, which accounts for 7% of global CO₂ emissions.

In particular there exists a need to be able to store CO₂ that can avoid monitoring costs of buoyant CO₂ for leakage.

In particular there exists a need to avoid the costs of deep drilling beyond >800 m depth for the storage of CO₂.

In particular there exists a need for a technology to be able to avoid regulatory hurdles involved in the injection of a super critical fluid in the subsurface for the storage of CO₂.

The present invention, among other things, solves one or more of these needs, a well as other needs, by providing the materials, compositions, and methods taught herein.

Thus, there is provided a method for geologic storage of CO₂ from modular point source emissions including the steps of: pumping brine water from a permeable reservoir; dissolving a CO₂ stream in brine water; and injecting the CO₂ into a storage aquifer to storage the CO₂; wherein the CO₂ is not a supercritical fluid.

Moreover, there is provided a method for geologic storage of CO₂ from modular point source emissions including the steps of: pumping brine water from a permeable reservoir; dissolving a CO₂ stream in brine water; and injecting the CO₂ into a storage aquifer to storage the CO₂; wherein the shallowest point of the aquifer is less than 800 m below a surface of the earth.

Additionally there is provided a system for geologic storage of CO₂ the system having: a CO₂ enrichment unit; the CO₂ enrichment unit including: an inlet for receiving a flow of a brine solution; an inlet for receiving a flow of gaseous CO₂; and, an outlet for removing an outflow from the enrichment unit; wherein the outlet is in fluid communication with a borehole in the earth; wherein the CO₂ enrichment unit is configured whereby the flow of gaseous CO₂ is in direct contact within the flow of the brine solution; and, wherein the outflow comprises a CO₂ rich brine; and the outflow is not a super critical fluid.

Further there is provided these systems and methods having one or more of the following features: wherein the borehole extends less than 1,000 m below a surface of the earth into a reservoir; wherein the borehole extends less than 800 m below the surface of the earth into the reservoir; having a second borehole in the earth extending into a reservoir, wherein the reservoir contains the brine solution, and the second borehole is in fluid communication with the inlet for receiving the flow of the brine solution; having a second borehole in the earth extending into the reservoir, wherein the reservoir contains the brine solution, and the second borehole is in fluid communication with the inlet for receiving the flow of the brine solution; wherein the CO₂ rich brine comprises H₂CO₃ (carbonic acid); wherein the CO₂ rich brine comprises one or more of the species H₊, HCO₃¹⁻ and CO₃²⁻; wherein the enrichment unit is a semi-open system; and wherein the enrichment unit is a semi-open system comprising one or more of a bubbler, a mixer, a falling brine solution, a brine sprayer, a CO₂ gas blanket, and a counter flow system.

Still further, there is provided a system for geologic storage of CO₂ generated from a source, the system having: a CO₂ enrichment unit; the CO₂ enrichment unit having: an inlet for receiving a flow of a brine solution from a reservoir in the earth; an inlet for receiving a flow of gaseous CO₂ from the source; and, an outlet for removing an outflow from the enrichment unit; wherein the outlet is in fluid communication with a borehole in the earth that extends into the reservoir; wherein the CO₂ enrichment unit is configured whereby the flow of gaseous CO₂ is in contact within the flow of the brine solution; and, wherein the outflow comprises a CO₂ rich brine; and the outflow is not a super critical fluid.

Moreover there is provided these systems and methods having one or more of the following features: wherein the borehole extends less than 1,000 m below a surface of the earth; wherein the borehole extends less than 800 m below the surface of the earth into the reservoir; having a second borehole in the earth extending into a reservoir, wherein the reservoir contains the brine solution, and the second borehole is in fluid communication with the inlet for receiving the flow of the brine solution; having a second borehole in the earth extending into the reservoir, wherein the reservoir contains the brine solution, and the second borehole is in fluid communication with the inlet for receiving the flow of the brine solution; wherein the CO₂ rich brine comprises H₂CO₃ (carbonic acid); wherein the CO₂ rich brine comprises one or more of the species H₊, HCO₃¹⁻ and CO₃²⁻; wherein the source of CO₂ is a cement plant; and, wherein the enrichment unit is a semi-open system.

Additionally, there is provided, a method for geologic storage of CO₂ generated from a source, the method including: flowing a brine solution from a brine source into a semi-open CO₂ enrichment system; flowing a gaseous CO₂ from the source into the semi-open CO₂ enrichment system; bringing the gaseous CO₂ into direct contact with the brine solution; whereby a CO₂ rich brine is formed; and, removing the CO₂ rich brine from the brine semi-open CO₂ enrichment system; and injecting the CO₂ rich brine into a reservoir below the surface of the earth.

In addition there is provided these systems and methods having one or more of the following features: wherein the CO₂ rich brine is a liquid, and is not a super critical fluid; wherein the borehole extends less than 1,000 m below a surface of the earth; wherein the borehole extends less than 800 m below the surface of the earth into the reservoir; wherein the borehole extend less than 700 m below the surface of the earth into the reservoir; wherein the brine solution is pumped from the reservoir, through a second borehole in the reservoir; wherein the CO₂ rich brine comprises H₂CO₃ (carbonic acid); wherein the CO₂ rich brine comprises one or more of the species H₊, HCO₃¹⁻ and CO₃²⁻; and, wherein the source of CO₂ is a cement plant.

### BRIEF DESCRIPTION

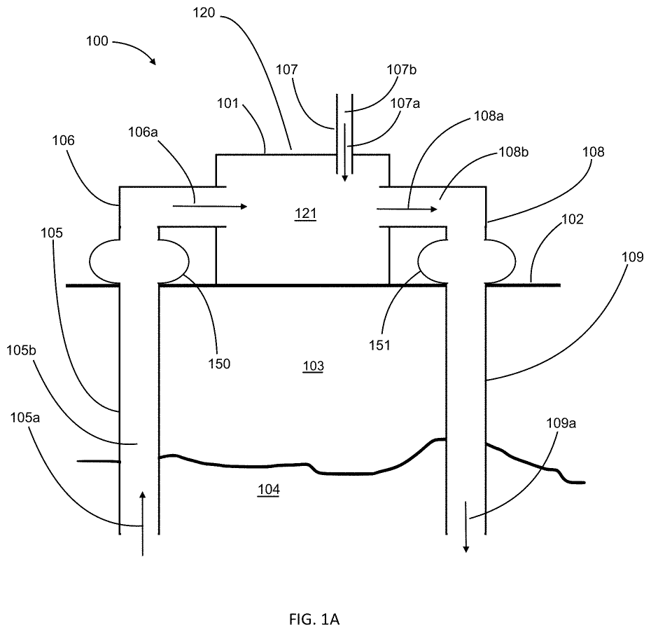

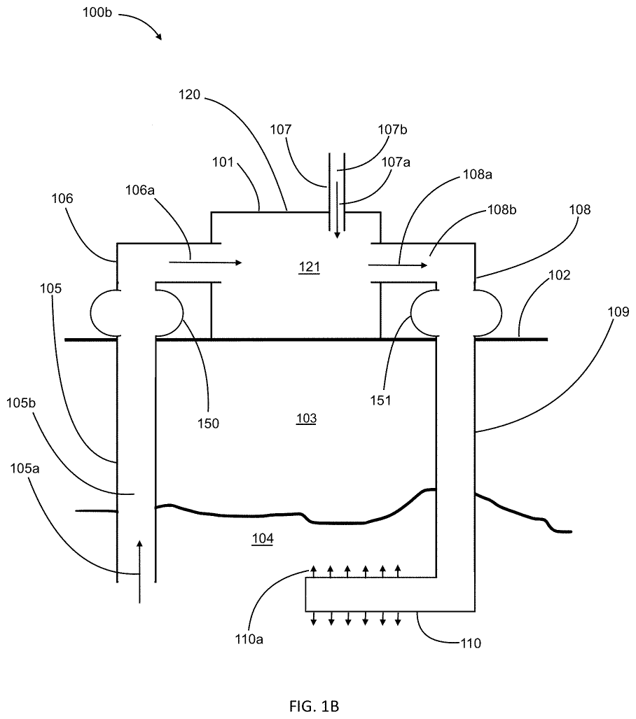

FIG. 1A is a schematic of an embodiment of a system and methods of dissolving CO₂ in saline for subsurface storage in accordance with the present inventions.

FIG. 1B is a schematic of an embodiment of a system and methods of dissolving CO₂ in saline for subsurface storage in accordance with the present inventions.

FIG. 2A is a phase diagram showing the solubility of CO₂ in water with temperature and pressure.

FIG. 2B is a graph showing the density of CO₂ as a function of pressure.

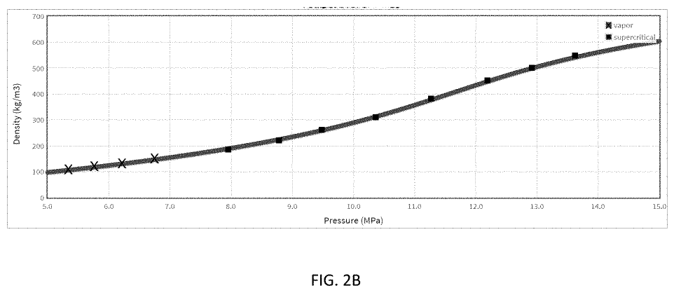

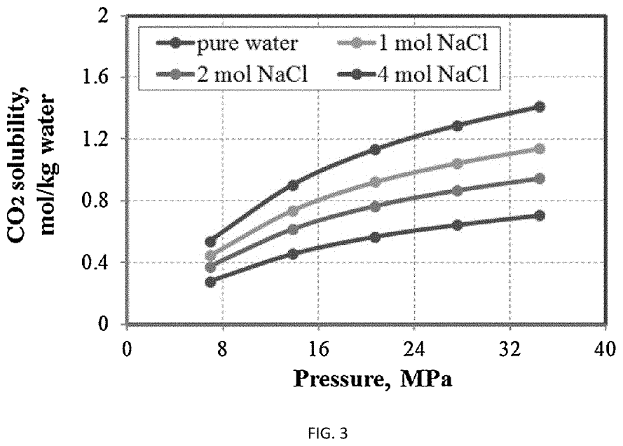

FIG. 3 is a graph showing the solubility of CO₂ in water for different salinity levels.

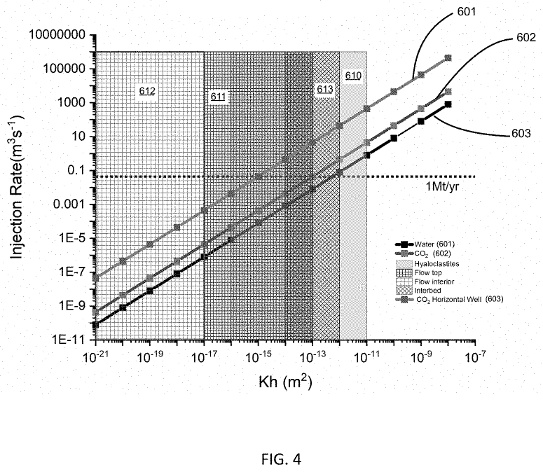

FIG. 4 is a graph showing injection rate vs. permeability of the reservoir (denoted by Kh, or permeability(k)×height/thickness (h)) in accordance with the present inventions.

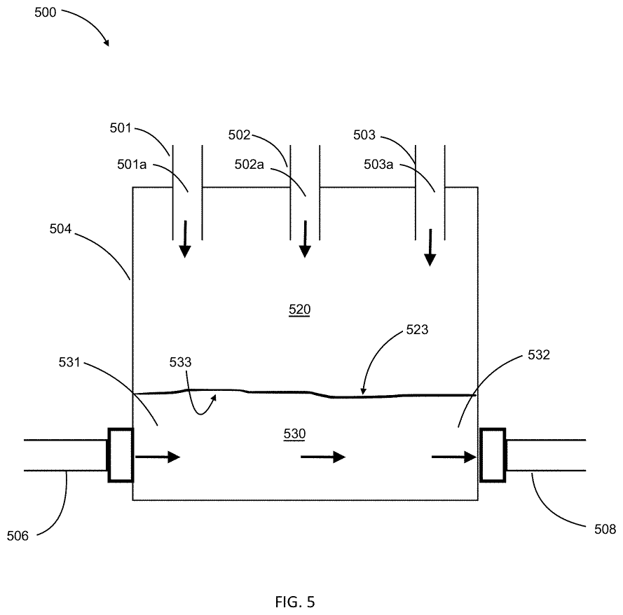

FIG. 5 is a schematic of an embodiment of a system and methods of dissolving CO₂ in saline for subsurface storage using an embodiment of a CO₂ enrichment reactor where an undersaturated solution of water is passed and flows counter flow to a stream of CO₂ in accordance with the present inventions.

### DESCRIPTION OF THE PREFERRED EMBODIMENTS

The present invention relates to technical and economic systems, methods and devices for the storage of CO₂ from a point source of CO₂

An embodiment of the present inventions relates to methods, systems and devices for the subsurface storage of CO₂ from an industrial point source that produces about 10 tons(“t”) of CO₂/day, about 50 t of CO₂/day, about 100 t of CO₂/day, about 200 t of CO₂/day, about 400 t of CO₂/day, from about 10 t to about 500 t of CO₂/day, from about 10 t to about 300 t of CO₂/day, from about 50 t to about 250 t of CO₂/day, from about 20 t to about 200 t of CO₂/day, less than 300 t of CO₂/day, less than 200 t of CO₂/day, less than 100 t of CO₂/day, less than 50 t of CO₂/day, and larger and smaller amounts, as well as, all amounts within these ranges. Although discussed as tons/day, it is understood that this could be average tons/day based on a weekly, monthly, annually, project or run basis. The CO₂ is dissolved in a brine or saline solution and then injected into a subsurface storage space, without the need to, and without using a SCF, i.e., without having to form, keep and maintain the CO₂ as a SCF. Thus, in embodiments of the present inventions, the CO₂ is dissolved in a brine or saline solution and then injected into a subsurface storage space in a formation in the ground, without forming, keeping and maintaining the CO₂ as a SCF.

An embodiment of the present inventions relates to methods, systems and devices for the subsurface storage of CO₂ from a modular industrial point source, for example a cement plant, having for example the daily production of CO₂ as discussed above. The CO₂ from this point source is dissolved in saline/brine solution and pumped into a subterranean storage space, e.g., a formation or reservoir within the earth. For example, the modular industrial point source can be one of the cement facilities set forth in US Application Publication No. 2022/0024818, the entire disclosure of which is incorporated herein by reference.

An embodiment of the present inventions relates to eliminating the need to use a supercritical fluid to store CO₂ in subsurface storage space. A particular embodiment of the present invention relates to storing CO₂ from a high purity modular point source of CO₂ from a cement facility.

The invention relates to a method of storing CO₂ in the subsurface. In an embodiment the method has three steps. The first step involves pumping of reservoir brine from a deep underground undrinkable aquifer, the second step involves dissolution of a high purity stream of CO₂ gas into reservoir brine, the third and final step involves re-injection of a reservoir brine into the deep underground aquifer permanently storing CO₂.

Thus, turning to FIG. 1A, there is shown a schematic of a method and system for subsurface CO₂ without using a SCF. The CO₂ subsurface storage system 100, has a CO₂ enrichment unit 101 that is located on the surface 102 of the earth 103. It being understood that the unit 101 can be subsurface, or above the surface. The surface 102 can be dry land, or the surface of a sea bed.

A subsurface brine reservoir 104 is located below the surface 102 in the earth 104. The brine reservoir can be about 100 m below the surface 102, about 200 m below the surface 102, about 300 m below the surface 102, from 50 m to 1,000 m below the surface 102, from 100 m to 790 m below the surface 102, less than 1,000 m below the surface 102, less than 800 m below the surface 102, less than 700 m below the surface 102, less than 500 m below the surface 102, less than 300 m below the surface 102, and deeper and shallower depths.

The brine in the brine reservoir 104 can have a salinity of from about 0.3 molar to about 5 molar, from about 0.5 molar to about 4 molar, from about 1 molar to about 3 molar, about 0.6 molar, more than 0.4 molar, more than 0.5 molar, more than 0.6 molar, more than 0.7 molar, and greater and smaller concentrations.

The brine 105b from brine reservoir 104 flows into well (e.g., cased or uncased borehole) 105 as shown by arrow 105a. The brine 105b flows through tubulars (e.g., pipe) 106 from the surface 102 into the enrichment unit 101, as shown by arrow 106a. CO₂ gas 107b is flowed into enrichment unit 101 by line (e.g., pipe) 107, as shown by arrow 107a. The CO₂ gas is from a point source or sources, as discussed in this Specification (but not shown in the drawing).

The unit 101 has an outflow 108b shown by arrow 108a into line 108 (e.g., pipe) that is then flowed into well 109 (e.g., cased or uncased borehole). The outflow 108a flows through well 109 where is it flowed (e.g., injected) back into reservoir 104, as shown by arrow 109a.

The outflow 108b has the CO₂ gas dissolved in the brine solution, and thus is a CO₂ rich brine, which is made up of H₂CO₃ (carbonic acid), which is present in equilibrium, as discussed in greater detail below, as species H₊, HCO₃¹⁻ and CO₃²⁻.

Turning to FIG. 1B the system 100b, is the embodiment of FIG. 1A (like numbers have like meaning) that has a horizontal well section 110 (preferably cased and perforated) that provides for flows (e.g., 110a) of outflow 108b into the reservoir 104.

The unit 101 has a housing 120 and has a means 121 within the housing to dissolve the CO₂ gas into the brine solution. The system 100 has a removal pump 150 for pumping the brine solution out of the reservoir and into the unit 101. The system has an injunction pump 151 for pumping the outflow (e.g., CO₂ rich brine) into the reservoir.

In this manner, the outflow 108 is returned to (e.g., injected into) the reservoir 104, where the dissolved CO₂ gas is captured and held in the reservoir 104.

The parameters, e.g., pressure and temperature, under which the outflow 108 is flowed (e.g., injected) into the reservoir 104 are such that the outflow 108 is not a SCF. Preferably, the flow rate and the pressure of the outflow is such that the pressure in the formation that holds reservoir 104 is kept below (i.e., does not exceed) the closure pressure of the formation holding the reservoir 104; and thus, the formation is not hydraulically fractured, i.e., no new fractures are formed in the formation holding the reservoir.

The focus of the present specification is toward any modular high purity point source of CO₂ emissions, these include process and energy emissions. An example of such a modular point source of CO₂ emissions are modular cement plants. Modular plants include any manufacturing or processing facility where its pre-built components, or systems, can be transported to a location of use, by truck, rail, ship or air, and then assembled at the location into an operation plant. These would include any type of recycling, processing and manufacturing facilities.

It should be understood that although the focus of the present Specification is on these modular point sources of emission, the present inventions find applicability in fixed point source, and for larger fixed sources such as coal fired electrical generation, steel making, carbon black manufacture and others.

In general, for embodiments of the present systems and methods the CO₂ gas is dissolved into the brine solution, using a means to dissolve the CO₂ gas into the brine. In an embodiment the means to dissolve the CO₂ gas into the brine is an enrichment unit. Preferably the enrichment unit is a semi-open system, e.g., CO₂ gas is brought into contact with the brine through bubbling, mixing, falling liquids or liquid sprays, surface interactions, counter flows, laminar flows, gas blankets, and other forms of having the gas in direct contact with the liquid. The mixing of the CO₂ with the brine may also be done by any other known and preferably commercially available systems for dissolving gases into liquids such as dissolving the gas into the brine within the injection well there by removing the need for a separate unit.

In an embodiment of such a semi-open enrichment system, the system has an inflow of CO₂ gas through a brine solution. The flowing brine solution is open to, and in direct contact with CO₂ gas. The CO₂ may also be injected or flowed into the flow of brine co-currently, e.g., bubbled into the brine in the injection well.

The mole percent of carbon dioxide gas in water in equilibrium with atmospheric air (˜2.37%) is almost 60 times the mole percent of carbon dioxide gas in atmospheric air (˜0.04%) while that of each of the other atmospheric gases is less than they are in atmospheric air. Thus, if CO₂ gas is input in a semi-open system where water (brine) that is undersaturated in CO₂ is continuously being fed into the system and the brine saturated with CO₂ is being removed from the system, CO₂ is net removed from the gas phase and dissolved into the liquid phase. The entrapment of the CO₂ into the brine to form a CO₂ rich brine can be referred to as the CO₂ enrichment stage in the process, i.e., the brine is enriched with CO₂.

Turning to FIG. 5 there is shown an embodiment of a CO₂ enrichment unit 500 for performing an enrichment stage. The semi-open enrichment unit 500 has a housing 504 that forms a chamber 505. The unit 500 has an inflow line 506, which flows (e.g., pumps) the brine solution from the reservoir that is depleted in CO₂ into the chamber 505. The unit 500 has an outflow line 508 that takes away CO₂ rich (e.g., saturated) brine solution from the chamber 505 for injection back into the reservoir. The brine solution 530 is flowed through the bottom of the chamber 505 and has a surface 533, which provides a surface area for contact and exchange with the CO₂ blanket 520. CO₂ gas 501a, 502a, 503a, is added to the chamber 505, from a point source or sources, through lines (e.g., pipes) 501, 502, 503. The CO₂ gas forms a CO₂ blanket 502 that has a surface 523, which provides a surface area for contact and exchange with the surface 533 of the flowing brine solution 530. The exchange of the CO₂ gas into the brine solution occurs across surface 523-533. In this manner the brine solution 531 is depleted in CO₂; and the brine solution 532 is rich in CO₂.

In embodiments the unit 500 is a part of the system 100 of FIGS. 1A and 1B.

In an embodiment, a system, such as the embodiment of FIGS. 1, 2 and 5 receives a high purity stream of CO₂ from the modular point source. In the dissolution process, carbon dioxide is dissolved into the water. Water used in this process is extracted from the injection reservoir.

The effect on the operating conditions in the semi-open enrichment systems can be any of those shown in FIGS. 2A, 2B and FIG. 3. In particular, any of the conditions shown FIG. 3 can be used, and any of the non-supercritical fluid conditions of FIGS. 2A and 2B can be used. In particular, the effect of salinity of the brine water and temperature on solubility is shown in these figures.

In an embodiment of the present CO₂ capture systems, including the semi-open systems, a water recycle pump pumps the water, e.g., a brine solution from the reservoir, in a continuous loop extracting water undersaturated with CO₂ then injecting CO₂ enriched water into the reservoir.

The injectivity of a single-phase fluid within a reservoir is given by the equation below:

$$Δ p = \frac{Q {μ}_{w}}{4 π k b} ( ln ( \frac{4 k t}{{ϕμ}_{w} {c}_{t} {r}^{2}} ) - 0.5772 )$$

Here Q is volumetric flow rate (m³/s), t is time, μ_{w} is the viscosity of water, k is permeability of the reservoir, b is thickness of the reservoir, r is the radius of the well, Ct is 5×10⁻⁹ Pa⁻¹, and ϕ is porosity. In general, a rule of thumb places a thermotical limit of a preferred injection pressure buildup to ˜150% of initial reservoir pressure. In general, a primary variable influencing the pressure build up is the permeability of the reservoir.

FIG. 4 shows the relationship between the maximum injection rate allowed to maintain safe injection pressures (<150%) and Kh (permeability×Thickness of the reservoir). The dotted black line shows an injection of 1 Mt of CO₂/year (0.048 m³s⁻¹), the amount required for an average coal fired power plant. The maximum acceptable injection rate for safe injection is plotted vs. Kh; for CO₂ dissolved in water, line 603 (black line), super-critical CO₂ via a vertical well, line 602 (redline) and scCO₂ via. a 1 km long horizontal well, line 601. Shaded regions show the range of permeability values for different types of formations: Hyaloclastites 610, Flow top 611, Flow interior 612, Interbed 613.

This present invention includes drilling of both vertical and horizontal wells for storage of water. It is understood that one or more existing wells that are not producing, e.g., depleted, abandoned or otherwise not being used, e.g., dry hole, can be used, and used in conjunction with, a newly drilled well. Horizontal wells as shown in FIG. 4 the graph above will increase the surface area and injectivity by up to two orders of magnitude.

Injection rates above the safe injection threshold presented in FIG. 4 lead to fracturing of the host rock and can potentially compromise the integrity of the wells. As a result it is important to consistently inject below this threshold, e.g., the closure pressure of the formation.

Unlike the injection of supercritical CO₂ which needs to be injected >800 m below the surface, the injection of CO₂ saturated water can be injected at much shallower depths into saine aquifers. These can be anywhere preferably from 100 m to >800 m in depth. Selection of aquifers will depend on local geology, brine composition and also the proximity of other potentially freshwater aquifers.

### EXAMPLES

The following examples provided illustrate various embodiments of the present systems, apparatus, and methods. These examples are for illustrative purposes, may be prophetic, and should not be viewed as, and do not otherwise limit the scope of the present inventions.

### Example 1

A system of the type shown in FIG. 1A or 1B having a semi-open enrichment unit of the type shown in operation to dissolve CO2 in a brine. The CO₂ enrichment reactor, the undersaturated solution of water (i.e., having little to no CO₂) is passed and flows counter flow or co-current to a stream of CO₂, here the water is saturated with CO₂ and the saturated water is re-injected into the aquifer. Constant removal of the saturated water, ensures constant depletion of CO₂ from the chamber, and thus ensures constant dissolution of the CO₂ into the water. In a prefer embodiment the water is a saline solution, and in a more preferred embodiment the water is a brine solution.

If the enrichment chamber has an atmosphere of CO₂ ˜2 MPa, the solubility of CO₂ in the brine would be ˜3 kg/100 kg of water. FIG. 2, there is shown a graph of the solubility of CO₂ in water (having various salinities) vs temperature). Based on these values, the dissolution of ˜100 t of CO₂ in a brine would require a 30,000 t of water. 30,000 t/day equates to an injection rate of ˜3.85×10-4 m3 per second. This injection rate enables a preferred injection in reservoirs with a permeability (K) >0.01 Darcy.

While dissolution of CO₂ in water and re-injection stores less CO₂, per pound of fluid injected, when compared to SCF injection, there are several key benefits that provide significant advantages over SCF injection. For example, CO₂ when dissolved in water is present as a bicarbonate ion, and as such the water with CO₂ is more-dense than the original reservoir water and upon injection this fluid will sink to the bottom of a reservoir and CO₂ will be trapped in the pore of this reservoir dissolved in water. In the presence of reactive alkali minerals, over time this slightly acidic solution could dissolve these minerals and form carbonate minerals following the equation below:

mM+2CO_{2(g)}+H₂O→sS+2HCO₃⁻+aA+bB+cSiO_{2(aq)}

Here, M is a silicate mineral, S a carbonate mineral and A and B are cations. When the pH recovers high enough, cations and bicarbonate ions in the fluid react to precipitate 2+2+2+ carbonates storing CO₂ as Ca/Mg/Fe carbonate. Thus, CO₂ could be stored in brine water or in the form of a mineral. In contrast when injecting CO₂ as a supercritical fluid CO₂ (SCF) is more buoyant, as a result it will rise to the top of a reservoir. So, a strong seal/caprock is required further more supercritical CO₂ can only be injected >800 m depth such that temperature and pressure are sufficient to maintain that CO₂ remains at a density such that it is in a supercritical phase and leakage remains less of an issue. CO₂ dissolved in water side steps these technical challenges, with the prior SCF approach, so that drilling or storage efforts do not have a minimum depth instead drilling only needs to be deep enough so that it avoids potential contamination of any drinking aquifers. The shallow depth requirement also reduces the cost in drilling the wells. In embodiments the depth could be as low as 200 m to 400 m deep instead of 800 m. This would greatly reduce the the drilling costs. Furthermore, given CO₂ is no longer in a plume of low density super critical fluid that needs to be monitored long term to avoid leakage, monitoring costs drop dramatically when CO₂ is dissolved in water. Such that CO₂ might not even need to be monitored if the reservoir has already been declared as isolated from any human drinking water. Furthermore, given the fluid will be denser—it's will sink and not rise. These key difference in storage relate to large cost savings when conducting a large-scale CO₂ storage project and regulatory approvals. This makes an ideal solution for modular sources of emission.

CO₂ saturated water creates a slightly acidic solution, in another embodiment injection of this solution may be used as an extraction technique to dissolve or leach specific alkali minerals in reservoirs by injecting the acidic solution and extracting or leaching key minerals and bringing this mineral rich fluid back to the surface where they are separated and the fluid is saturated with CO₂ and re-injected.

It is noted that there is no requirement to provide or address the theory underlying the novel and groundbreaking performance or other beneficial features and properties that are the subject of, or associated with, embodiments of the present inventions. Nevertheless, various theories are provided in this specification to further advance the art in this important area, and in particular in the important area of cement and materials manufacture, calcining, pyrolysis, cost controls and minimizing greenhouse gasses. These theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the operation, function and features of embodiments of the methods, articles, materials, devices and system of the present inventions; and such later developed theories shall not limit the scope of protection afforded the present inventions.

The various embodiments of the processes, methods, assemblies, activities and operations set forth in this specification may be used in the above identified fields and in various other fields. Further, the various embodiments set forth in this specification may be used with each other in different and various combinations. Thus, for example, the configurations provided in the various embodiments of this specification may be used with each other. For example, the components of an embodiment having A, A′ and B and the components of an embodiment having A″, C and D can be used with each other in various combination, e.g., A, C, D, and A. A″ C and D, etc., in accordance with the teaching of this Specification. The scope of protection afforded the present inventions should not be limited to a particular embodiment, configuration or arrangement that is set forth in a particular embodiment, example, or in an embodiment in a particular Figure.

The invention may be embodied in other forms than those specifically disclosed herein without departing from its spirit or essential characteristics. The described embodiments are to be considered in all respects only as illustrative and not restrictive.

1-28. (canceled)

29. A system for geologic storage of CO₂, the system comprising:
a CO₂ enrichment unit;
the CO₂ enrichment unit comprising:
an inlet for receiving a flow of a brine solution;
an inlet for receiving a flow of gaseous CO₂; and,
an outlet for removing an outflow from the enrichment unit;
wherein the outlet is in fluid communication with a borehole in the earth;
wherein the CO₂ enrichment unit is configured whereby the flow of gaseous CO₂ is in direct contact within the flow of the brine solution; and,
wherein the outflow comprises a CO₂-rich brine, and the outflow is not a super critical fluid.

30. The system of claim 29, wherein the borehole extends less than 1,000 m below a surface of the earth into a reservoir.

31. The system of claim 29, comprising a second borehole in the earth extending into a reservoir, wherein the reservoir contains the brine solution, and the second borehole is in fluid communication with the inlet for receiving the flow of the brine solution.

32. The system of claim 29, wherein the CO₂-rich brine comprises H₂CO₃ (carbonic acid).

33. The system of claim 29, wherein the CO₂-rich brine comprises one or more of the species H₊, HCO₃¹⁻ and CO₃²⁻.

34. The system of claim 29, wherein the enrichment unit is a semi-open system.

35. The system of claim 29, wherein the enrichment unit is a semi-open system comprising one or more of a bubbler, a mixer, a falling brine solution, a brine sprayer, a CO₂ gas blanket, and a counter flow system.

36. The system of claim 29, wherein the inlet is for receiving a flow of the brine solution from a reservoir in the earth.

37. The system of claim 29, wherein the CO₂ is generated from a source.

38. The system of claim 29, wherein the source of CO₂ is a cement plant.

39. The system of claim 29, wherein the enrichment unit is a semi-open system.

40. A method for geologic storage of CO₂ generated from a source, the method comprising:
flowing a brine solution from a brine source into a semi-open CO₂ enrichment system;
flowing a gaseous CO₂ from the source into the semi-open CO₂ enrichment system;
bringing the gaseous CO₂ into direct contact with the brine solution; whereby a CO₂-rich brine is formed;
removing the CO₂-rich brine from the brine semi-open CO₂ enrichment system; and
injecting the CO₂-rich brine into a reservoir below the surface of the earth.

41. The method of claim 40, wherein the CO₂-rich brine is a liquid, and is not a super critical fluid.

42. The system of claim 40, wherein the borehole extends less than 1,000 m below a surface of the earth.

43. The system of claim 40, wherein the brine solution is pumped from the reservoir, through a second borehole in the reservoir.

44. The methods of claim 40, wherein the CO₂-rich brine comprises H₂CO₃ (carbonic acid) and/or one or more of the species H₊, HCO₃¹⁻ and CO₃²⁻.

45. The methods of claim 40, wherein the source of CO₂ is a cement plant.

46. A method for geologic storage of CO₂ from modular point source emissions comprising:
pumping brine water from a permeable reservoir;
dissolving a CO₂ stream in brine water; and
injecting the CO₂ into a storage aquifer to store the CO₂.

47. The method of claim 46, wherein the CO₂ is not a supercritical fluid.

48. The method of claim 46, wherein the shallowest point of the aquifer is less than 800 m below a surface of the earth.
